(19) United States
(12) Patent Application Publication
(10) Pub. No.: US 2022/0048233 A1
(43) Pub. Date: Feb. 17, 2022

(54) RECIPROCATING BLOW-MOLDING MACHINE

(71) Applicant: Uniloy, Inc., Tecumseh, MI (US)

(72) Inventors: Frederick A. Loesch, Britton, MI (US); Chase D. Blasius, Tecumseh, MI (US); John S. Rosenbeck, Jackson, MI (US)

(21) Appl. No.: 17/401,701

(22) Filed: Aug. 13, 2021

Related U.S. Application Data
(60) Provisional application No. 63/065,700, filed on Aug. 14, 2020.

(51) Int. Cl. B29C 48/30; B29C 49/04; B29C 49/78; B29C 48/32

(52) U.S. Cl. CPC B29C 48/301; B29C 49/04; B29L 2031/7158; B29C 48/304; B29C 48/32; B29C 49/78

(57) ABSTRACT

A blow-molding machine includes an extruder, a manifold, and at least one die head having a view-stripe spider. The manifold is coupled to the extruder. The die head is coupled to the manifold. The blow-molding machine is configured to form a blow-molded container including a container body and a view stripe using the die head.

### PRIORITY CLAIM

This application claims priority under 35 U.S.C. § 119(e) to U.S. Provisional Application No. 63/065,700, filed Aug. 14, 2020, the content of which is expressly incorporated by reference herein in its entirety.

### BACKGROUND

The present disclosure relates to a molding machine, and particularly to a blow-molding machine. More particularly, the present disclosure relates to a blow-molding machine and process for establishing a view stripe on a container formed by the blow-molding machine.

### SUMMARY

According to a first aspect of the present disclosure, a blow molding machine includes an extruder, a view-stripe manifold coupled to the extruder, and a die block assembly. The extruder may be a reciprocating extruder that processes a view-stripe polymer resin and discharges the view-stripe resin into the view-stripe manifold. The view-stripe manifold distributes the processed view-stripe polymer resin to the die-block assembly. The die-block assembly combines the view-stripe resin and container resin to form one or more blow-molded containers with a view-stripe that provides a window in the container for a consumer to view a remaining level of contents therein.

In illustrative embodiments, the die-block assembly includes a plurality of die heads that each receive individual streams of view-stripe resin from the view-stripe manifold to produce multiple containers with each cycle. Each die head includes a housing, a mandrel assembly, a die, and a view-stripe spider. The housing defines an internal passageway that extends along an axis. The mandrel assembly and the die cooperate with the housing to form a blow-molded parison using the container resin and the view-stripe resin. The view-stripe spider receives the view-stripe resin from the view-stripe manifold and is configured to add the view-stripe resin to the container resin to produce the view stripe on the container after the parison is blow molded in a die head.

In illustrative embodiments, the view-stripe spider is positioned relative to the housing, the mandrel assembly, and the die so that the view-stripe spider can form a clear and straight view stripe on the container. The view-stripe spider is positioned below a downstream distal tip of a mandrel sleeve included in the mandrel assembly and directly upstream of the die. The location of the view-stripe spider corresponds to a zone of relatively stable pressure within the internal passageway. In some embodiments, the view-stripe spider is positioned axially between two higher pressure zones. In some embodiments, the view-stripe spider is positioned axially between two variable-pressure zones.

In illustrative embodiments, the view-stripe spider includes an annular body that is shaped in the form of a ring and a view-stripe former is coupled to the annular body. The view-stripe former extends inwardly into the internal passageway to interact with the container resin flowing there through. In some embodiments, the view-stripe former has a cross section in the shape of a tear-drop. The shape of the view-stripe former divides the container resin to provide spacing for injection of the view-stripe resin in a straight line and allows for knitting of the container resin to the view-stripe resin downstream of the view-stripe former to form a seamless container with a view stripe.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a sectional view taken along line 1-1 in FIG. 10 of a die head of a blow-molding machine in accordance with the present disclosure including, a view-stripe manifold, and a die-block assembly having a plurality of die heads coupled to the view-stripe manifold to receive a view-stripe polymer resin from the extruder that is used to create a view stripe on a container, as shown in FIG. 1A, after being processed through each die head, and showing that each die head includes a housing that defines a feed throat, a mandrel located within the feed throat, a die that cooperates with the housing and the mandrel to form the container, and a view-stripe spider located within the feed throat between a mandrel sleeve tip and the die and configured to form the view stripe on the container as the die head forms the container;

FIG. 1A is a perspective view of a container formed from one of the die heads and including a container body and a view stripe that extends along the container body and is transparent so that a user can determine a level of product remaining within an interior storage space of the container;

FIG. 2 is an enlarged view of a portion of the view-stripe spider from FIG. 1 showing that the view-stripe spider includes a tear-drop shaped view-stripe former that separates the container polymer resin and injects the view-stripe polymer resin into the container polymer resin for integration with the container polymer resin as the container is formed in the die head;

FIG. 3 is a perspective view of the blow-molding machine from FIG. 1, showing that the machine further includes a horizontally oriented barrel, a tube connected to the barrel at a top end and connected to the view stripe manifold at a bottom end, the barrel and tube cooperating to transport polymer resin to the view stripe manifold;

FIG. 4 is an offset sectional view of the blow-molding machine from FIG. 1 taken along the barrel and tube in part and a die assembly in part, showing the flow path of the barrel, the tube, and the view stripe manifold standoff;

FIG. 5 is perspective and a diagrammatic view of the blow-molding machine of FIG. 1 showing that the blow-molding machine further includes a control system that synchronizes extrusion of the view-stripe polymer resin from the extruder and a container polymer resin used to form the container body;

FIG. 6A is a cross sectional view of one of the die heads taken along line 4A-4A in FIG. 1;

FIG. 6B is a cross sectional view of one of the die heads taken along line 4B-4B in FIG. 6A;

FIG. 7 is a perspective view of the view-stripe spider showing that the view-stripe spider includes an annular body and the view-stripe former that extends inwardly from the annular body and showing that the annular body is formed to include a circumferential slot that opens into a passageway formed in the view-stripe former to allow for angular variances when the view-stripe spider is located in the die head to properly deliver full and constant flow by avoiding dead spots;

FIG. 8 is a top sectional view taken along line 8-8 in FIG. 7 of the view-stripe spider showing that the view-stripe former is formed to include an outlet slot that releases the view-stripe polymer resin at location where the container polymer resin is rejoined to integrate the view-stripe polymer resin with the container resin and form the container;

FIG. 9 is a sectional view taken along line 9-9 in FIG. 8 through a center of the view-stripe former;

FIG. 10 is a sectional view taken along line 10-10 in FIG. 15 showing that the manifold includes a longitudinal manifold body, an associated standoff for each of the die heads that extends from the manifold body, and a removable plug that can be separated from the longitudinal manifold body to clean residual view-stripe polymer resin from the manifold body;

FIG. 11 is a partial perspective view of a portion of the manifold and one of the die heads with a section cut away along line 11-11 in FIG. 5 to show the view-stripe polymer resin flow path from the manifold to the die head;

FIG. 12 is a perspective view of a second illustrative container formed using the blow-molding machine to have a view stripe;

FIG. 13 is a perspective view of a third illustrative container formed using the blow-molding machine to have a view stripe;

FIG. 14 is a perspective view of a blow-molding machine according to a further aspect of the present disclosure, showing that the machine includes a vertically oriented barrel, a tube connected to the barrel at a top end and connected to the view stripe manifold at a bottom end, the barrel and tube cooperating to transport polymer resin to the view stripe manifold; and

FIG. 15 is a front view of the blow-molding machine from FIG. 14, showing that the vertically oriented barrel, the tube connected to the barrel, and the barrel connected to the view stripe manifold.

### DETAILED DESCRIPTION

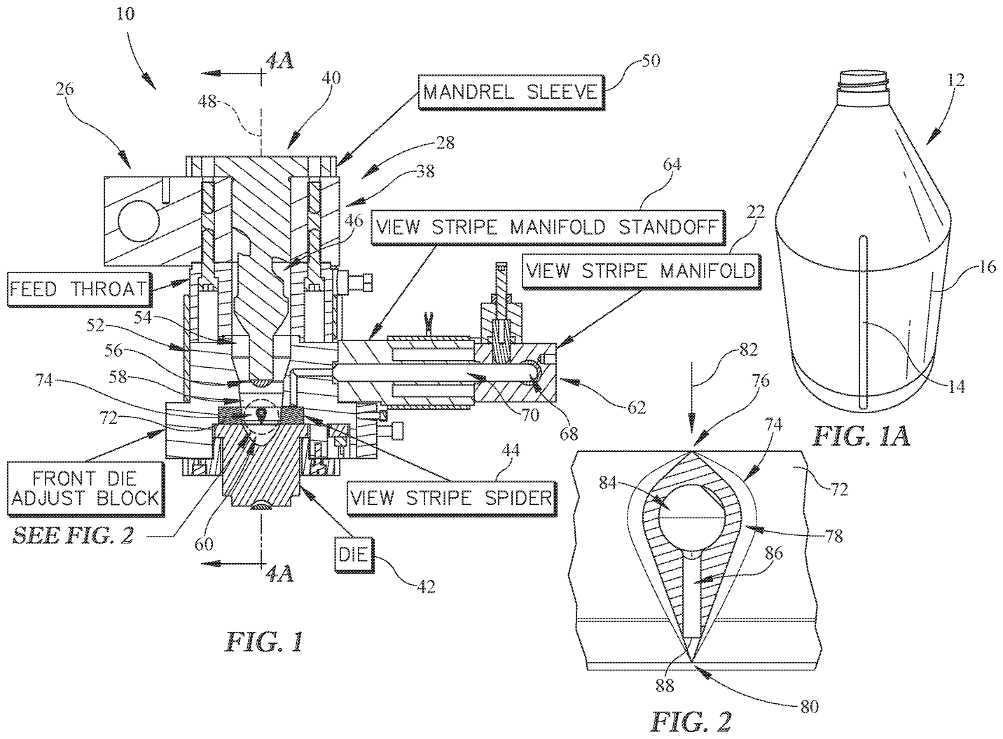

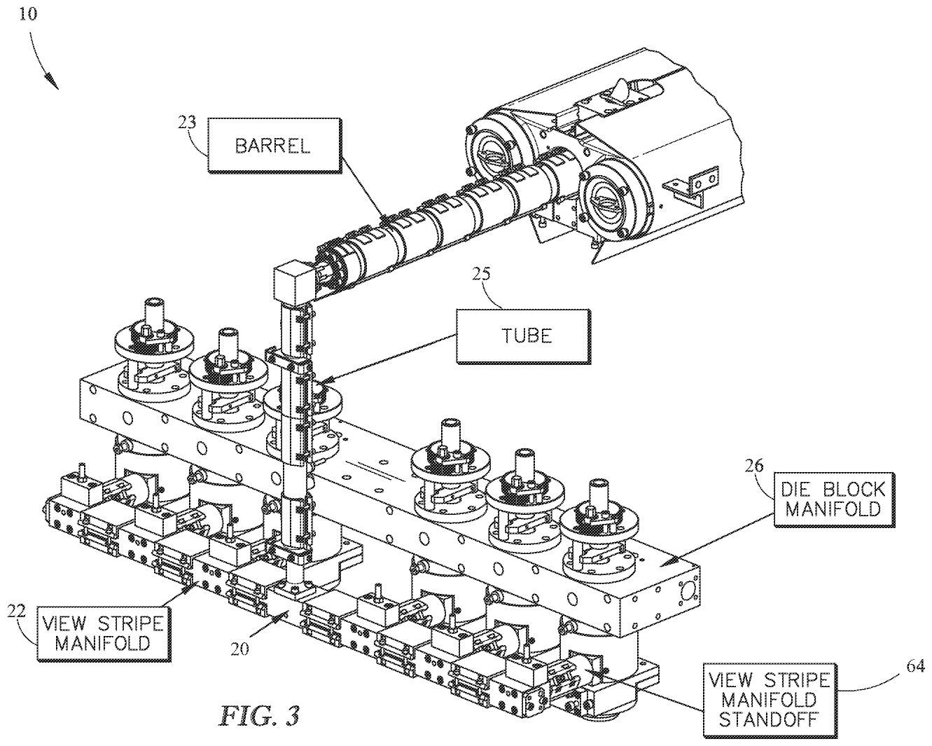

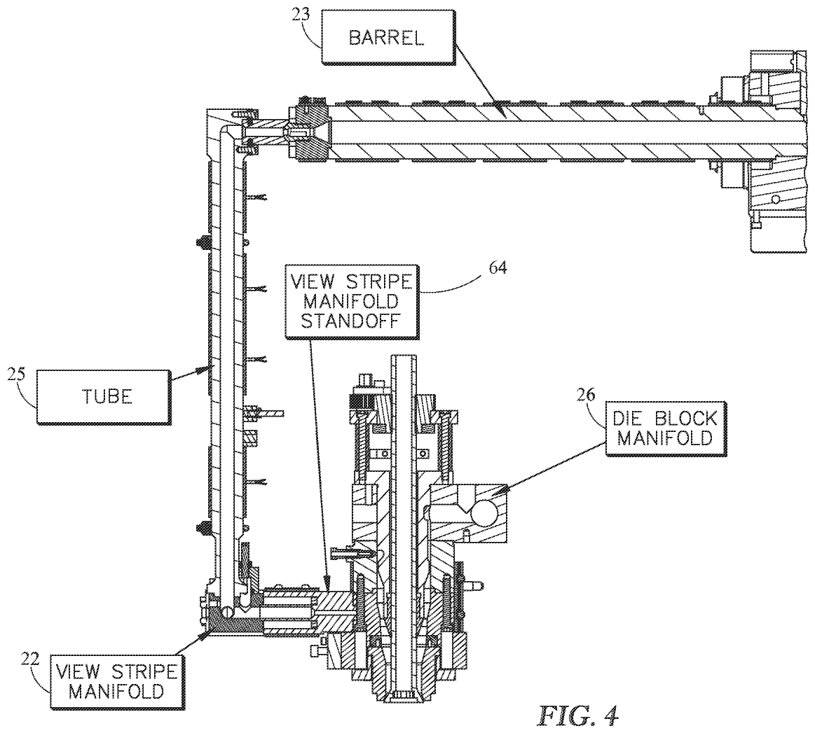

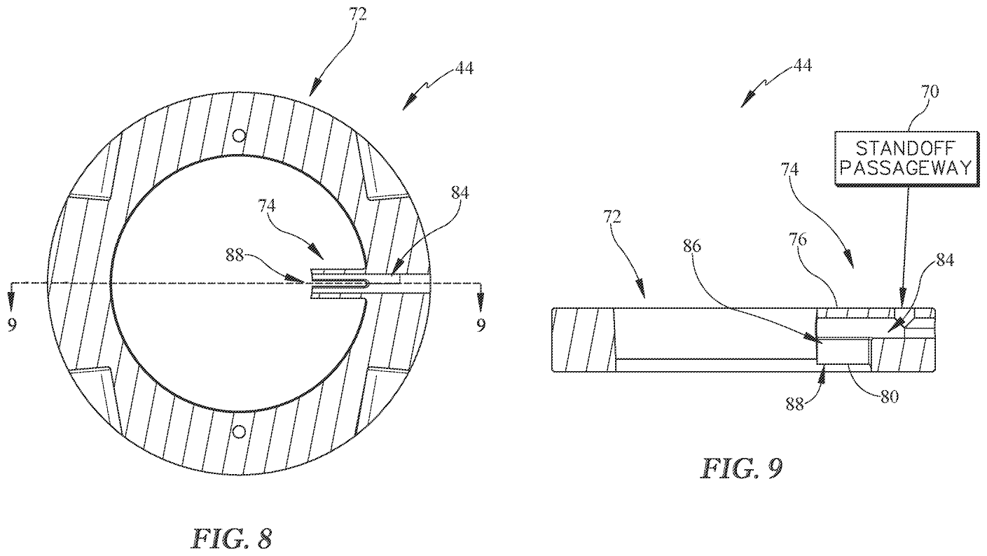

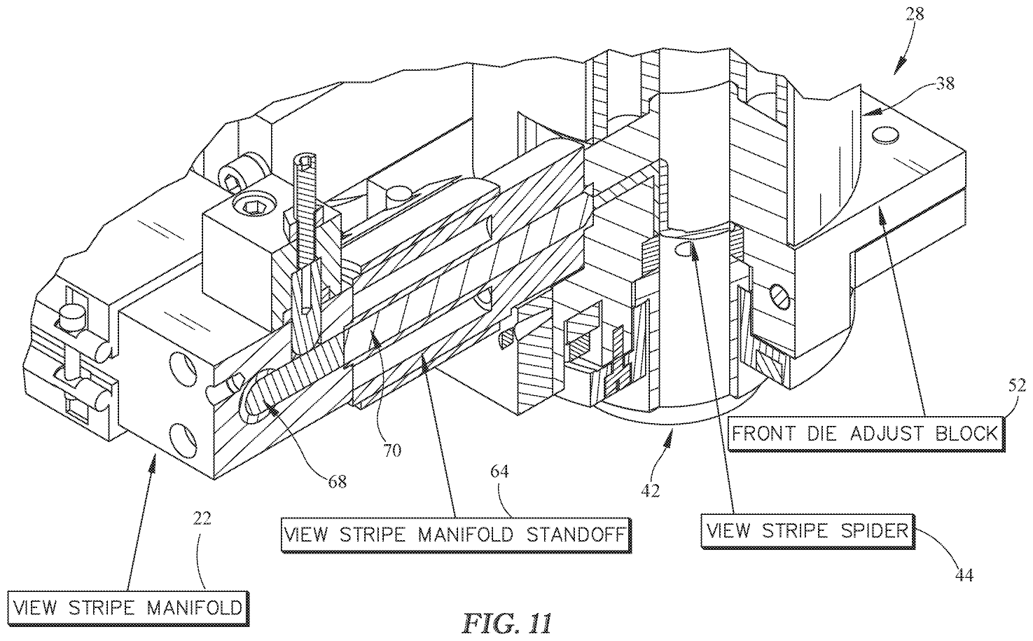

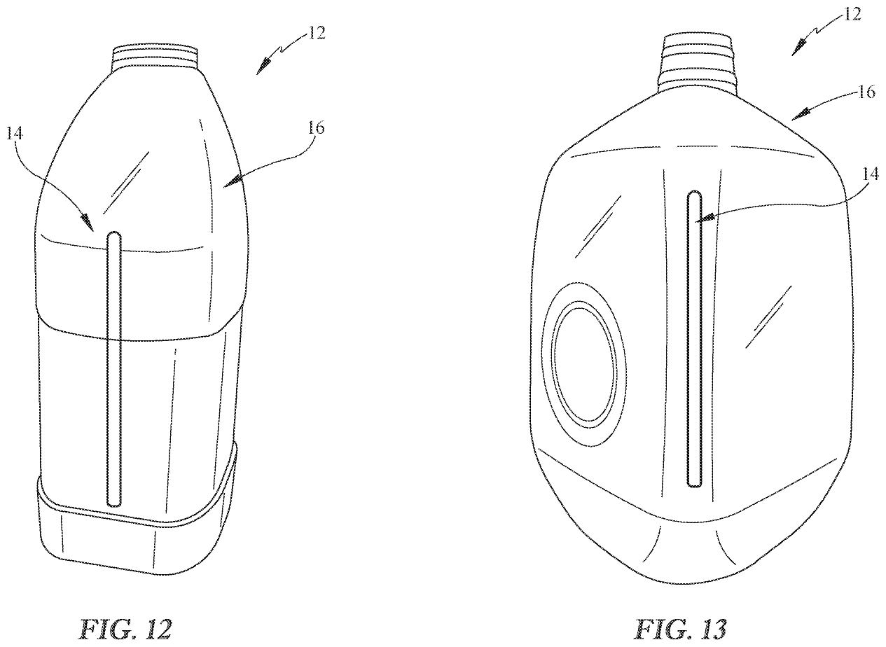

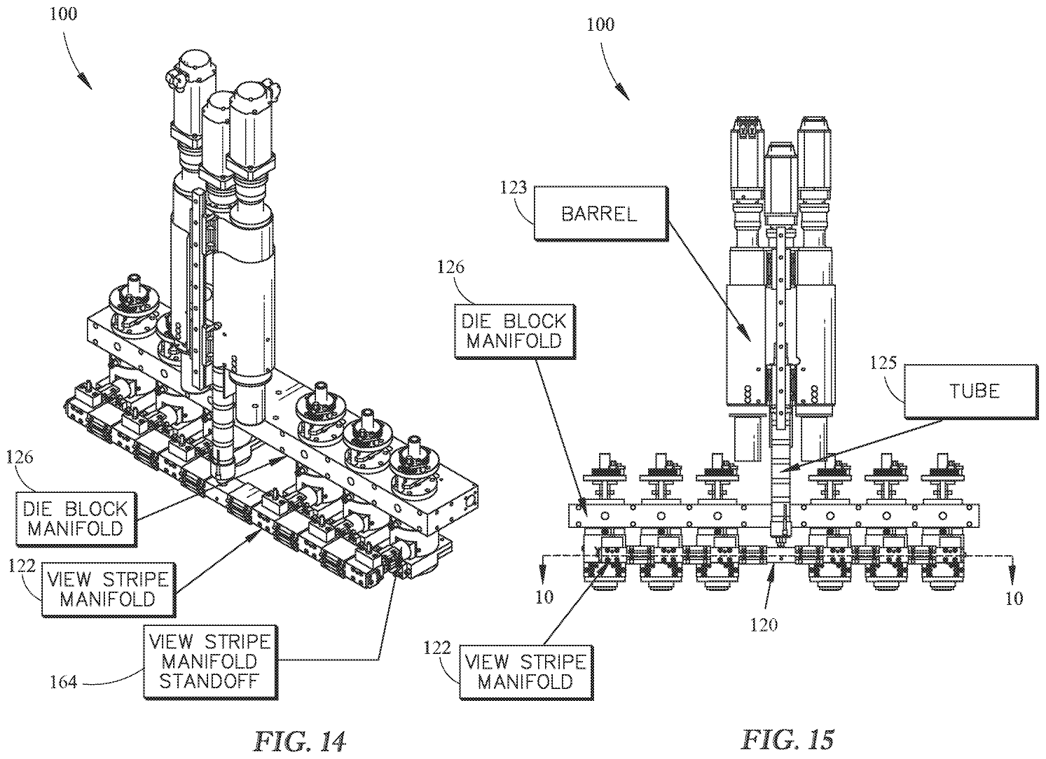

A blow-molding machine 10 according to a first embodiment of the present disclosure is shown in FIGS. 1-13. A blow-molding machine 100 according to a second embodiment of the present disclosure is shown in FIGS. 14 and 15.

A blow-molding machine 10, as shown in FIGS. 1-13, is configured to produce a container 12 (i.e. a container or bottle) with a view stripe 14 as shown in FIG. 1A to allow viewing of a remaining level of product within the container 12. The blow-molding machine 10 includes a die assembly 24 having a die block manifold 26 and a plurality of die heads 28 coupled to the die-block manifold 26. Each die head 28 includes a housing 38, a mandrel assembly 40, a die 42, and a view-stripe spider 44. The view-stripe spider 44 includes an annular body 72 and a view-stripe former 74. The view-stripe former 74 has a cross section in the shape of a tear-drop configured to divide container resin flowing through the die 28 and past the view-stripe former 74 in a downward direction 82 so as to provide spacing for injection of a view-stripe resin in a straight line. Subsequently, knitting of the container resin to the view-stripe resin is performed so as to form the view stripe 14 on the finished container 12.

The blow-molding machine 10 includes an extruder 20, a view-stripe manifold 22 coupled to the extruder 20, and a die block assembly 24 as shown in FIGS. 1-4. The extruder 20 is a reciprocating extruder that is oriented in a horizontal direction relative to the view-stripe manifold 22 and the die block assembly 24. For example, a barrel 23 is oriented horizontally relative to the view-stripe manifold 22 and the die block assembly 24. A tube 25 is fluidically connected at a top end to a terminal end of the barrel 23 and is oriented vertically relative to the view-stripe manifold 22 and the die block assembly 24. The tube 25 is fluidically connected at a bottom end to the view-stripe manifold 22. The polymer resin is configured to flow through the barrel 23, through the tube 25, and into the view-stripe manifold 22. Because the view-strip manifold 22 contains large amounts of molten polymer resin and is compressible, orienting the tube 25 to be vertical allows for the amount of volume of polymer resin flowing into the manifold 22 to be minimized.

The extruder 20 is supplied with the view-stripe polymer resin and processes the view-stripe polymer resin for discharge into the view-stripe manifold 22. The view-stripe manifold 22 is configured to distribute the processed view-stripe polymer resin from the extruder 20 to the die-block assembly 24. The die-block assembly 24 is configured to receive the processed view-stripe resin and the container resin. The die-block assembly 24 is configured to form the container 12 by combining the view-stripe resin and the container resin to produce the container 12 with the view-stripe 14 shown in FIG. 1A.

The container 12 includes a container body 16 and the view stripe 14 as shown in FIG. 1A. The container body 16 and the view stripe 14 are integrated together by the die-block assembly 24 to form a one-piece container 12. The container resin forms the container body while the view-stripe resin forms the view stripe 14. The view-stripe resin is a transparent material so that the view stripe 14 provides a see-through window on the container 12. A user may use the view stripe 14 to view and determine a remaining level of product within the container 12. Various containers 12 may be formed by the blow-molding machine 10 having the view-stripe 14 and differently shaped container bodies 16 as shown in FIGS. 1A, 12, and 13.

The die-block assembly 24 is configured to produce multiple containers 12 each having a view stripe 14 without mixing the view-stripe resin with the container resin so as to maintain clarity of the view stripe 14 on the finished container 12. The die-block assembly 24 includes the die block manifold 26 and the plurality of die heads 28 coupled to the die-block manifold 26, as shown in FIGS. 1-4. The die-block manifold 26 is configured to retain each of the die heads 28 together and may house various electronics components that control operation of each die block as will be described. Each die head 28 is configured to receive the view-stripe resin and the container resin and combine the view-stripe resin and the container resin to form a single container 12 from a parison blown in each die head 28.

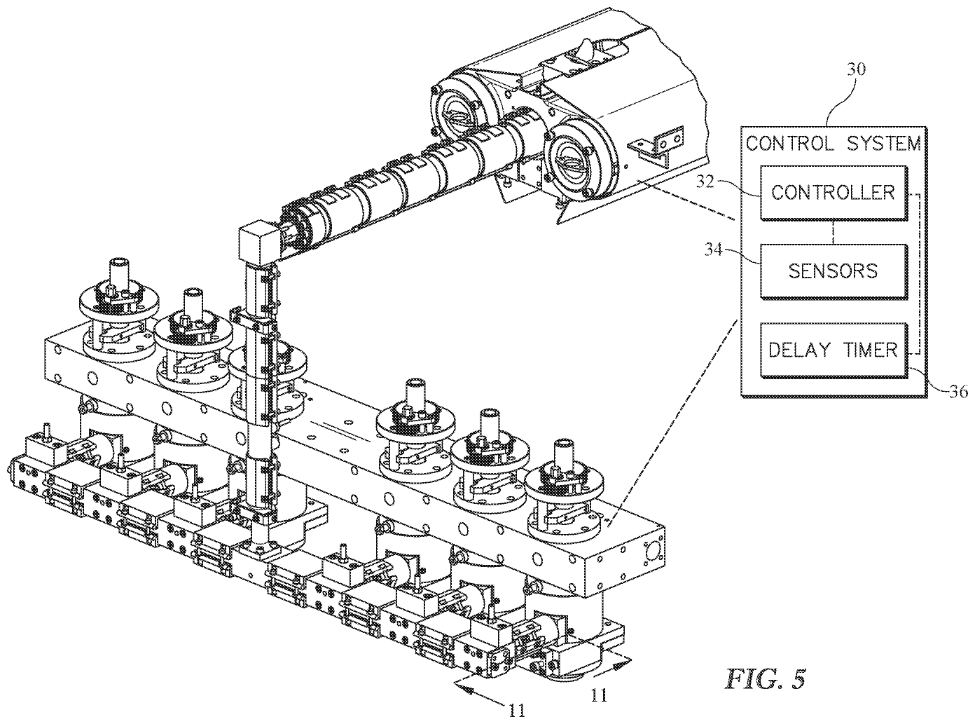

The blow-molding machine 10 further includes a control system 30 that controls all of the operations of the container forming process, as shown in FIG. 5. The control system 30 includes a controller 32, one or more sensors 34, and a delay timer 36 as shown in FIG. 2. The controller 32 may be internal or external to the blow-molding machine 10 and is able to perform all of the functions of the blow-molding machine in response to signals received from the one or more sensors 34 and the delay timer 36. The controller 32 includes a micro-processor and a memory storage device storing instructions that, when executed by the micro-processor, cause the blow-molding machine 10 to form a container 12. The one or more sensors 34 may include a thermo-couple for sensing a temperature of the view-stripe resin and the container resin and/or other sensors that sense flow characteristics of the view-stripe resin and the container resin. The delay timer 36 is configured to regulate the operation of various components of the blow-molding machine 10, such as the extruder 20 and each of the die heads 28, to ensure that each resin is added to the die head 28 at an appropriate time to produce the container 12 with the view stripe 14.

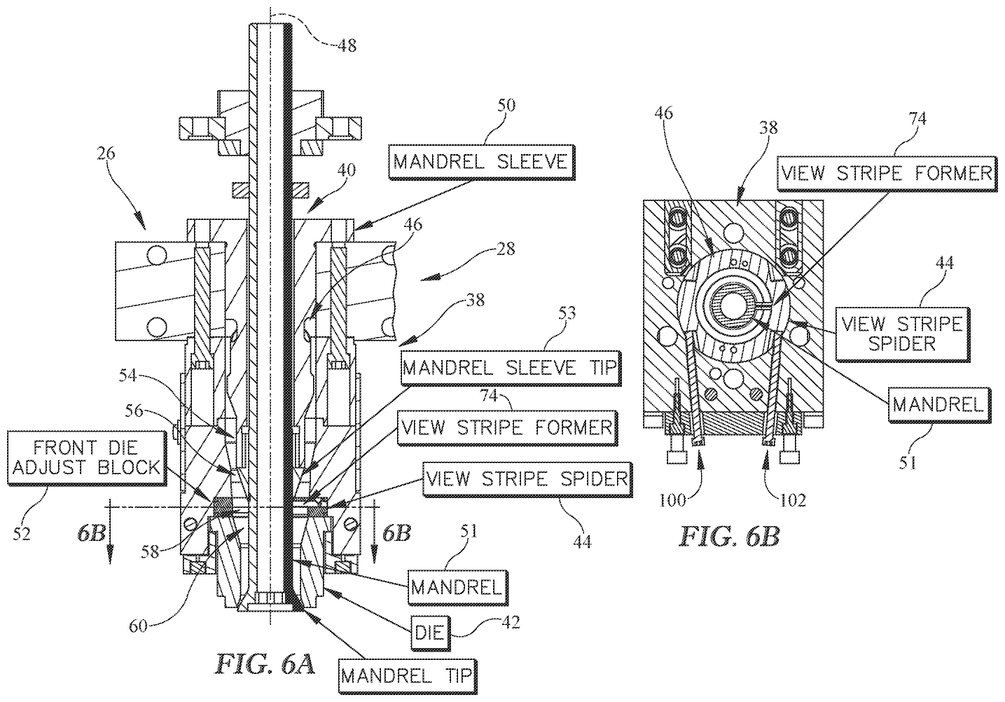

Each die head 28 includes a housing 38, a mandrel assembly 40, a die 42, and a view-stripe spider 44 as shown in FIGS. 1, 6A and 6B. The housing 38 defines an internal passageway 46 that extends along an axis 48. The mandrel assembly 40 includes a mandrel sleeve 50 arranged to lie at least partially in the internal passageway 46 and a mandrel 51 that extends through an interior of the mandrel sleeve 50 along the axis 48. The mandrel sleeve 50 is arranged to lie in a portion of the internal passageway 46 upstream of view spider 44 defined by a die adjustment block 52, or front die adjust block, which forms at least a portion of the housing 38. The mandrel sleeve 50 has an outer contour that cooperates with an inner contour of the die adjustment block 52 to form the container 12 as the container resin is advanced through the internal passageway 46. The die 42 is coupled to the die adjustment block 52 at a downstream end of the housing 38. The view-stripe spider 44 is arranged to lie axially between the mandrel sleeve 50 and the die 42 along the axis 48. The view-stripe spider 44 also defines a portion of the internal passageway 46 and is configured to add the view-stripe resin to the container resin to produce the view stripe 14 on the container 12 once the parison is finished being processed.

A flow area for the container resin is provided in the internal passageway 46 between the mandrel sleeve 50 and the housing 38 upstream of the view-stripe spider 44 before the container resin is combined with the view-stripe resin with the view-stripe spider 44, as shown in FIGS. 1, 6A, and 6B. The flow area varies as the internal passageway 46 extends toward the die 42. The varying flow area establishes a zone of low pressure 54 followed by a zone of higher pressure 56 located downstream from the zone of low pressure 54. A zone of relatively stable pressure 58 is located downstream of both the zone of low pressure 54 and the zone of higher pressure 56. Downstream of the zone of relatively stable pressure 58 is another zone 60 of increased pressure.

The view-stripe spider 44 is positioned relative to the housing 38, the mandrel assembly 40, and the die 42 and relative to the pressure zones 54, 56, 58, 60 to optimize formation of the view stripe 14 on the parison, as shown in FIGS. 1 and 6. The view-stripe spider 44 is positioned below a downstream distal tip 53 of the mandrel sleeve 50 and directly upstream of the die 42. The location of the view-stripe spider 44 corresponds to the last pressure change caused by the housing 38 and the mandrel sleeve 50 in pressure zones 54 and 56. The view-stripe spider 44 is positioned within the zone of relatively stable pressure 58 so that the view-stripe spider 44 forms the view-stripe 14 in a substantially constant strip along the parison as the view-stripe resin is added to the container resin. Accordingly, the view-stripe spider 44 is positioned axially between two higher pressure zones 56, 60 and/or between stable pressure zone 58 and variable-pressure zone 60.

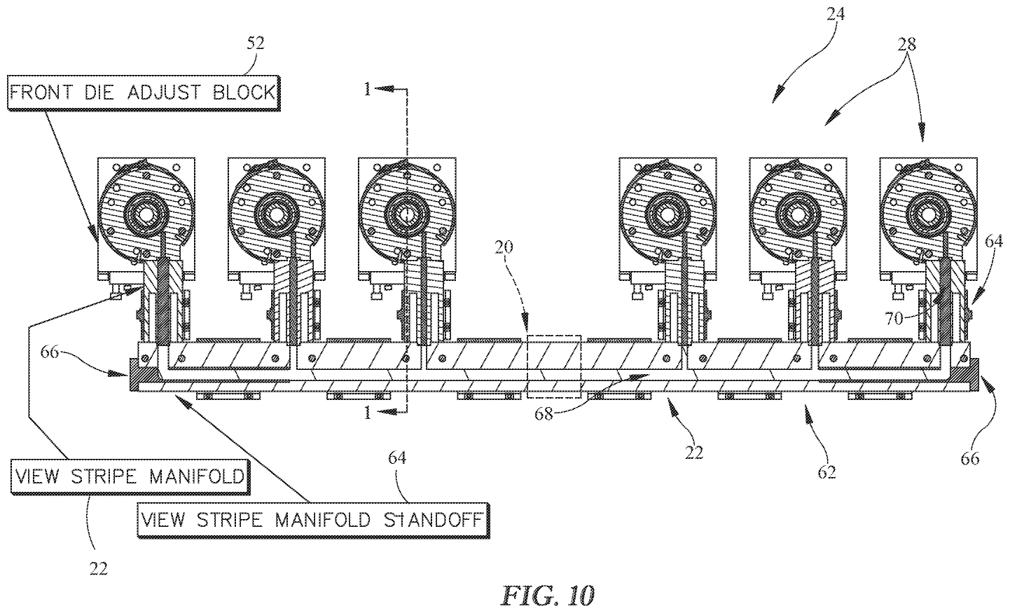

The view-stripe resin is fed to the die head 28 from the view-stripe manifold 22 as suggested in FIG. 1. The view-stripe manifold 22 includes a longitudinal manifold body 62, a plurality of view stripe manifold standoffs 64, and a removable plug 66 (FIG. 10). The longitudinal manifold body 62 is formed to include a longitudinal passageway 68 that delivers the view-stripe resin to each manifold standoff 64 and die head 28. Each manifold standoff 64 corresponds with one of the die heads and is formed to include a standoff flow passageway 70 that delivers and balances the view-stripe resin to the view-stripe spider 44. In some embodiments, in order to improve production of the container 12, the size of the standoff flow passageway 70, in particular the diameter of the passageway, is minimized.

The view-stripe spider 44 includes an annular body 72 and a view-stripe former 74 as shown in FIGS. 2, 6B, and 7-9. The annular body 72 is shaped in the form of a ring having an inner surface that partially defines the internal passageway 46. The view-stripe former 74 is coupled to the annular body 72 and extends inwardly into the internal passageway 46 to interact with the container resin flowing there through. A radially inner surface of the view-stripe former 74 is curved about axis 48 to match a radius if curvature of the mandrel 51. The view-stripe former 74 engages the mandrel 51 to block resin from flowing therebetween.

The view-stripe former 74 has a cross section in the shape of a tear-drop as shown in FIGS. 1 and 2. The view-stripe former includes an upstream point 76, a body 78 and a downstream point 80. The upstream point 76 is shaped to divide the container resin flowing past the view-stripe former 74 in a downward direction 82. The body 78 is formed to include an outlet passageway 84 that delivers the view-stripe resin to the internal passageway 46. The outlet passageway 84 has a discharge portion 86 that opens downwardly toward the die 42 into the internal passageway 46 to discharge the view-stripe resin in the downward direction 82 of travel of the container resin. The body 78 is shaped to taper inwardly as it extends toward the downstream tip 80 to cause the container resin to reconvene at the downstream tip 80 where the view-stripe resin is discharged into the internal passageway 46 at an outlet 88. The container resin and the view-stripe resin combine at the outlet 88 and downstream tip 80 and are integrated together by the die 42 and mandrel 51 to provide a seamless container 12 once the parison is finished being blown. In this way, the shape of the view-stripe former 74 divides the container resin to provide spacing for injection of the view-stripe resin in a straight line and allows for knitting of the container resin to the view-stripe resin to form view stripe 14 on the finished container 12.

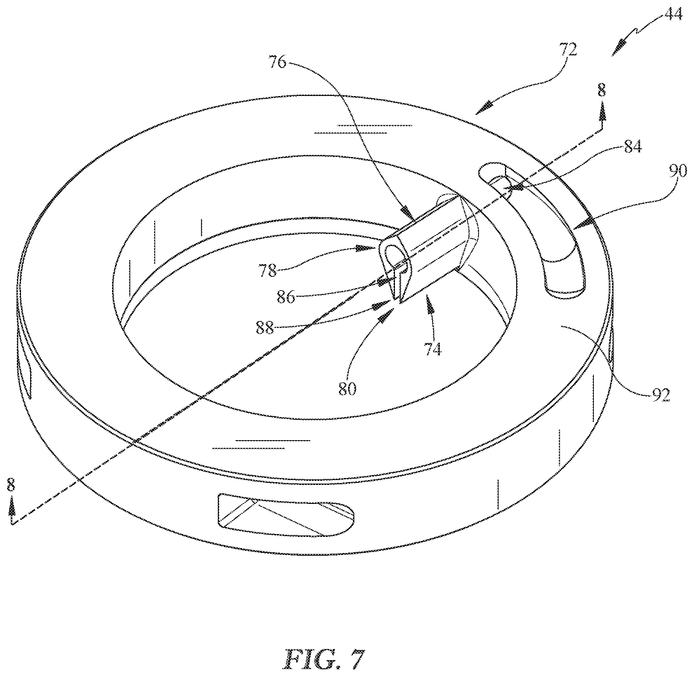

The annular view-stripe body 72 is formed to include a circumferential slot 90 formed in an upper portion 92 of the annular view-stripe body 72 as shown in FIG. 7. The circumferential slot 90 extends partway around the annular view-stripe body 72 to allow for variances in angular orientation of the view-stripe spider 44 relative to the standoff passageway 70. The standoff passageway 70 includes a portion 71 that opens toward the slot 90 and extends circumferentially about axis 48 with the slot 90 to widen a flow path defined partially by the slot 90 so that no dead spots are formed which would block the flow of view-stripe resin to view-stripe former 44. In the illustrative embodiment, the slot 90 extends about 15 degrees around the annular view-stripe body 72 to provide about 15 degrees of variance. In other embodiments, more or less variance may be provided by making the slot 90 larger or smaller. The view-stripe spider 44 may be rotated relative to the housing 38 and mandrel assembly 40 about axis 48 by rotating adjustment pins 100, 102 as shown in FIG. 6B.

The removable plug 66 of the view-stripe manifold 22 arranged in sliding engagement with the manifold body 62 and extends into the longitudinal passageway 68 as shown in FIG. 10. The removable plug 66 is inserted into the passageway 68 to block flow of the view-stripe resin out of each end of the longitudinal body 62. The removable plug 66 may be separated from the longitudinal body 62 thereby allowing for removal of any residual view-stripe resin from the longitudinal passageway 68 and the standoff passageways 70 for cleaning. In the illustrative embodiment, a removable plug 66 is provided at both ends of the longitudinal body 62 to allow for removal of residual view-stripe resin from the passageway 68 at both ends.

Each standoff passageway 70 may vary in diameter to regulate the flow of view-stripe resin as shown in FIG. 10. The standoff passageways 70 closest to extruder 20 may have a relatively small diameter while the standoff passageways further from the extruder 20 may have relatively larger diameters so that flow through each standoff passageway 70 is equal. The diameters of the standoff passageways may vary differently if the extruder 20 is not located in a central location relative to all of the manifold standoffs 64 so that flow through each standoff passageway 70 is equal.

A blow-molding machine 100 according to a further aspect of the present disclosure is shown in FIGS. 14 and 15. The blow-molding machine 100 is similar to the blow-molding machine 10 shown in FIGS. 1-13 and described herein. Accordingly, similar reference numbers in the 100 series indicate features that are common between the blow-molding machine 100 and the blow-molding machine 10. The description of the blow-molding machine 10 is incorporated by reference to apply to the blow-molding machine 100, except in instances when it conflicts with the specific description and the drawings of the blow-molding machine 100.

The blow-molding machine 100, similar to the blow-molding machine 10, includes an extruder 120, a view-stripe manifold 122 coupled to the extruder 120, a die block assembly 124, and a view stripe manifold standoff 164, as shown in FIGS. 14 and 15. Unlike the blow-molding machine 10, the extruder 120 is oriented vertically relative to the view-stripe manifold 122 and the die block assembly 124. Specifically, both the barrel 123 and the tube 125 are oriented vertically relative to the view-stripe manifold 122 and the die block assembly 124. In some embodiments, a central axis of a flow path through the barrel 123 is parallel with a central axis of a flow path through the tube 125. The polymer resin is configured to flow through the barrel 123, through the tube 125, and into the view-stripe manifold 122.

1. A blow-molding machine comprising
a reciprocating extruder configured to heat and advance view-stripe resin, and
a die head configured to receive the view-stripe resin and a container resin and combine the view-stripe resin and the container resin to form a blow-molded container including a container body and a view stripe,
wherein the die head includes a housing defining an internal passageway that directs the container resin in a first direction along an axis, a mandrel assembly including a mandrel and a mandrel sleeve located within the internal passageway and at least partially spaced apart from the housing to define a flow path therebetween, a die located downstream of the mandrel sleeve, and a view-stripe spider located between a downstream distal tip of the mandrel sleeve and the die and configured to divide the container resin and discharge the view-stripe resin in the first direction and combine the container resin with the view-stripe resin to provide the container with the view stripe when the container is formed by the die and the mandrel.

2. The blow-molding machine of claim 1, wherein the view-stripe spider includes an annular body that partially defines the internal passageway and a view-stripe former that extends into the internal passageway away from an inner wall of the annular body.

3. The blow-molding machine of claim 2, wherein the view-stripe former includes an upstream tip configured to separate the container resin, a view-stripe body that is formed to include a view-stripe passageway that receives the view-stripe resin, and a downstream tip spaced apart from the upstream tip such that the view-stripe former tapers toward the downstream tip.

4. The blow-molding machine of claim 3, wherein the view-stripe passageway has an outlet at the downstream tip that opens away from the upstream tip to discharge the view-stripe resin in the first direction as the container resin passes the view-stripe former.

5. The blow-molding machine of claim 2, wherein the annular body has an inner surface that partially defines the internal passageway and the view-stripe former extends into the internal passageway.

6. The blow-molding machine of claim 5, wherein the view-stripe former contacts the mandrel.

7. The blow-molding machine of claim 2, wherein the annular body is formed to include a slot formed in an upstream surface of the annular body and the slot extends part-way circumferentially around the axis.

8. The blow-molding machine of claim 7, wherein the housing is formed to include a standoff passageway that is aligned with the slot to deliver the view-stripe resin therein, and wherein the standoff passageway includes a portion that extends in a circumferential direction to coincide with the slot and to widen a flow path defined partially by the slot.

9. The blow-molding machine of claim 8, wherein the slot extends about 15 degrees around the axis.

10. The blow-molding machine of claim 1, further comprising a control system including a controller, at least one sensor configured to provide sensor signals to the controller, and a delay timer configured to synchronize discharge of the view-stripe resin from the extruder to the view-stripe spider and discharge of the container resin through the internal passageway to form the container with the view stripe.

11. The blow-molding machine of claim 1, further comprising a view-stripe manifold that distributes the view-stripe resin toward a plurality of die heads.

12. A blow-molding machine comprising
a reciprocating extruder configured to heat and advance view-stripe resin, and
a die head configured to receive the view-stripe resin and a container resin and combine the view-stripe resin and the container resin to form a blow-molded container including a container body and a view stripe,
wherein the die head includes a housing, a mandrel assembly including a mandrel and a mandrel sleeve, a die located downstream of the mandrel sleeve, and a view-stripe spider located between a downstream distal tip of the mandrel sleeve and the die and configured to divide the container resin and discharge the view-stripe resin and combine the container resin with the view-stripe resin to provide the container with the view stripe.

13. The blow-molding machine of claim 12, wherein the view-stripe spider includes an annular body that partially defines the internal passageway and a view-stripe former that extends into the internal passageway away from an inner wall of the annular body.

14. The blow-molding machine of claim 13, wherein the view-stripe former includes an upstream tip configured to separate the container resin, a view-stripe body that is formed to include a view-stripe passageway that receives the view-stripe resin, and a downstream tip spaced apart from the upstream tip such that the view-stripe former tapers toward the downstream tip.

15. The blow-molding machine of claim 14, wherein the view-stripe passageway has an outlet at the downstream tip that opens away from the upstream tip to discharge the view-stripe resin in the first direction as the container resin passes the view-stripe former.

16. The blow-molding machine of claim 13, wherein the annular body has an inner surface that partially defines the internal passageway and the view-stripe former extends into the internal passageway.

17. A method of forming a container with a view stripe comprising
heating and advancing view-strip resin via a reciprocating extruder,
receiving the view-stripe resin and a container resin in a die head including a housing defining an internal passageway that directs the container resin in a first direction along an axis, a mandrel assembly including a mandrel and a mandrel sleeve located within the internal passageway and at least partially spaced apart from the housing to define a flow path therebetween, a die located downstream of the mandrel sleeve, and a view-stripe spider located between a downstream distal tip of the mandrel sleeve and the die,
dividing the container resin and discharging the view-stripe resin in the first direction via the view-stripe spider, and
combining the view-stripe resin and the container resin via the die head and the mandrel to form a blow-molded container including a container body and a view stripe.

18. The method of claim 17, wherein the view-stripe spider includes an annular body that partially defines the internal passageway and a view-stripe former that extends into the internal passageway away from an inner wall of the annular body.

19. The method of claim 18, wherein the view-stripe former includes an upstream tip configured to separate the container resin, a view-stripe body that is formed to include a view-stripe passageway that receives the view-stripe resin, and a downstream tip spaced apart from the upstream tip such that the view-stripe former tapers toward the downstream tip.

20. The method of claim 19, further comprising:
discharging the view-stripe resin in the first direction as the container resin passes the view-stripe former via an outlet at the downstream tip of the view-stripe passageway that opens away from the upstream tip.
